(19) United States
(12) Patent Application Publication
(10) Pub. No.: US 2026/0020511 A1
(43) Pub. Date: Jan. 22, 2026

(54) HYDRAULIC CONTROL SYSTEM FOR AN AGRICULTURAL TILLAGE IMPLEMENT

(71) Applicant: CNH Industrial America LLC, New Holland, PA (US)

(72) Inventor: Heath A. Toennies, Eureka, IL (US)

(21) Appl. No.: 18/776,814

(22) Filed: Jul. 18, 2024

(51) Int. Cl. A01B 63/32; A01B 49/02; A01B 63/00; F15B 13/02

(52) U.S. Cl. CPC A01B 63/32; A01B 63/008; F15B 13/024; F15B 13/025; F15B 13/027; A01B 49/027; F15B 2211/50554

(57) ABSTRACT

A hydraulic control system for an agricultural implement includes a hydraulic circuit configured to receive hydraulic fluid from a first end of a gauge device cylinder. The gauge device cylinder is configured to couple to a tool frame of the agricultural implement and to a gauge device frame of the agricultural implement. Furthermore, the hydraulic circuit is configured to control a pressure of the hydraulic fluid within a first end of a frame force cylinder based on a pressure of the hydraulic fluid within the first end of the gauge device cylinder. The frame force cylinder is configured to couple to the tool frame, and the frame force cylinder is configured to apply a frame force to the tool frame.

### BACKGROUND

The present disclosure relates to a hydraulic control system for an agricultural tillage implement.

Certain agricultural implements include ground engaging tools configured to interact with soil. For example, a tillage implement may include disc blades configured to break up a top layer of the soil for subsequent planting or seeding operations. The disc blades may be arranged in a front row and a rear row. As the tillage implement traverses a field, the forces acting to drive the disc blades into the soil may become unbalanced, thereby resulting in variations in the penetration depth of the disc blades. Accordingly, the disc blades may break up the top layer of the soil at varying depths, which may reduce the effectiveness of the tillage operation.

### BRIEF DESCRIPTION

In certain embodiments, a hydraulic control system for an agricultural implement includes a hydraulic circuit configured to receive hydraulic fluid from a first end of a gauge device cylinder. The gauge device cylinder is configured to couple to a tool frame of the agricultural implement and to a gauge device frame of the agricultural implement. Furthermore, the hydraulic circuit is configured to control a pressure of the hydraulic fluid within a first end of a frame force cylinder based on a pressure of the hydraulic fluid within the first end of the gauge device cylinder. The frame force cylinder is configured to couple to the tool frame, and the frame force cylinder is configured to apply a frame force to the tool frame.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having a hydraulic control system;

FIG. 2 is a perspective view of a portion of the tillage implement of FIG. 1;

FIG. 3 is a schematic diagram of an embodiment of a hydraulic control system that may be employed within the tillage implement of FIG. 1; and

FIG. 4 is a schematic diagram of another embodiment of a hydraulic control system that may be employed within the tillage implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

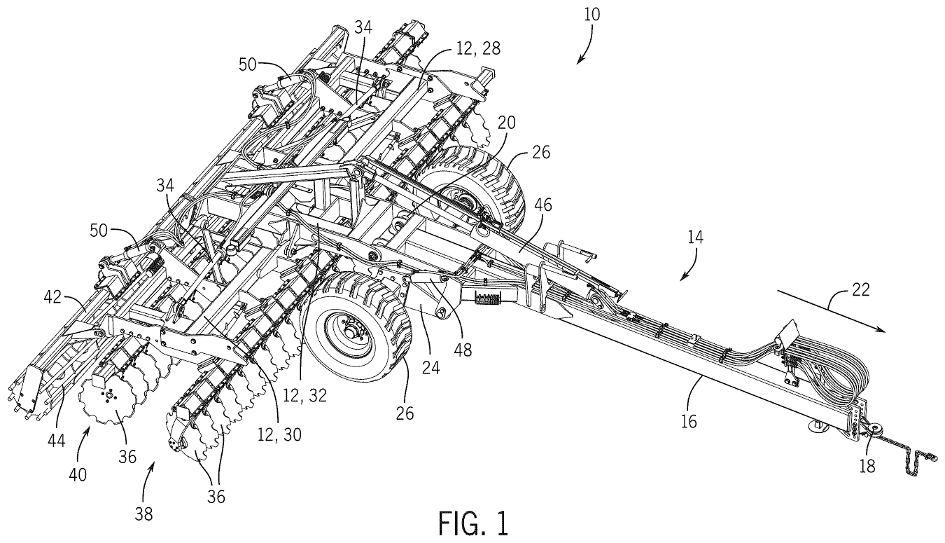

FIG. 1 is a perspective view of an embodiment of a tillage implement 10 (e.g., agricultural tillage implement, agricultural implement) having a hydraulic control system. In the illustrated embodiment, the tillage implement 10 is a high speed compact tillage implement having multiple ground engaging tools configured to till soil. As illustrated, the tillage implement 10 includes a main frame 12 (e.g., tool frame) and a hitch assembly 14 pivotally coupled to the main frame 12. In the illustrated embodiment, the hitch assembly 14 includes a hitch frame 16 and a hitch 18. The hitch frame 16 is pivotally coupled to the main frame 12 via pivot joint(s) 20, and the hitch 18 is configured to couple to a corresponding hitch of a work vehicle (e.g., tractor), which is configured to tow the tillage implement 10 through a field along a direction of travel 22.

Furthermore, the tillage implement 10 includes a wheel frame 24 pivotally coupled to the hitch frame 16 of the hitch assembly 14. In the illustrated embodiment, the tillage implement 10 includes two wheels 26 rotatably coupled to the wheel frame 24. The wheels 26 are configured to engage a surface of the field and to support a portion of the weight of the tillage implement 10 as the tillage implement 10 is towed through the field along the direction of travel 22. While the tillage implement 10 includes two wheels 26 in the illustrated embodiment, in other embodiments, the tillage implement may include more or fewer wheels rotatably coupled to the wheel frame (e.g., 1, 3, 4, 5, 6, or more). Furthermore, in certain embodiments, the tillage implement may include one or more tracks (e.g., alone or in combination with one or more wheels). While the wheel frame is coupled to the hitch frame by a pivotal connection in the illustrated embodiment, in other embodiments, the wheel frame may be movably coupled to the hitch frame by another suitable connection (e.g., sliding connection, linkage assembly, etc.) that facilitates adjustment of a vertical position of the wheels relative to the hitch frame.

In the illustrated embodiment, the main frame 12 includes a left wing section 28 and a right wing section 30. Each wing section is pivotally coupled to a center section 32 of the main frame 12. Furthermore, the tillage implement 10 includes wing actuators 34 configured to urge each wing section downwardly relative to the center section 32. Each wing actuator 34 is coupled to the center section 32 and to a respective wing section. While the main frame 12 includes the center section 32, the left wing section 28, and the right wing section 30 in the illustrated embodiment, in other embodiments, the main frame may include more or fewer sections. For example, in certain embodiments, the main frame may be substantially rigid (e.g., not including any wing sections). In such embodiments, the wing actuators may be omitted. Furthermore, the main frame 12 may be formed from multiple frame elements (e.g., rails, tubes, braces, etc.) coupled to one another (e.g., via welded connection(s), via fastener connection(s), etc.).

In the illustrated embodiment, the tillage implement 10 includes disc blades 36 configured to engage a top layer of the soil. As the tillage implement 10 is towed through the field along the direction of travel 22, the disc blades 36 are driven to rotate, thereby breaking up the top layer of the soil. In the illustrated embodiment, the disc blades 36 are arranged in a front row 38 and a rear row 40. However, in other embodiments, the disc blades may be arranged in more or fewer rows (e.g., 1, 3, 4, 5, 6, or more). Furthermore, in the illustrated embodiment, each disc blade 36 is independently mounted to the main frame 12. Accordingly, each disc blade 36 may rotate independently of the other disc blades 36. While each disc blade 36 is independently mounted to the main frame 12 in the illustrated embodiment, in other embodiments, at least a portion of the disc blades may be mounted to the main frame in one or more gangs, in which the disc blades of each gang are configured to rotate together as the tillage implement is towed through the field.

Furthermore, in the illustrated embodiment, the tillage implement 10 includes a rolling basket frame 42 (e.g., gauge device frame) pivotally coupled to the main frame 12. The tillage implement 10 also includes a rolling basket 44 (e.g., gauge device) rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. In the illustrated embodiment, the rolling basket frame 42 includes a left section pivotally coupled to the left wing section 28 of the main frame 12, and the rolling basket frame 42 includes a right section pivotally coupled to the right wing section 30 of the main frame 12. In addition, the rolling basket 44 includes a left section rotatably coupled to the left section of the rolling basket frame 42, and the rolling basket 44 includes a right section rotatably coupled to the right section of the rolling basket frame 42. In certain embodiments (e.g., in embodiments in which the main frame is substantially rigid), the rolling basket frame may have a single section, and/or the rolling basket may have a single section. In addition, in certain embodiments (e.g., in embodiments in which the main frame includes more than two sections), each rolling basket frame section may be pivotally coupled to a respective main frame section, and each rolling basket section may be rotatably coupled to a respective rolling basket frame section.

While the tillage implement includes the disc blades 36 and a rolling basket 44 in the illustrated embodiment, in other embodiments, the tillage implement may include other/additional ground engaging tool(s). For example, in certain embodiments, the tillage implement may include tillage point assemblies (e.g., positioned behind the disc blades and in front of the rolling basket relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades and in front of the rolling basket relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), other suitable ground engaging tool(s), or a combination thereof. Furthermore, while the tillage implement 10 is a high speed compact tillage implement in the illustrated embodiment, in other embodiments, the tillage implement may be a primary tillage implement, a vertical tillage implement, a strip tillage implement, or another suitable type of tillage implement.

In the illustrated embodiment, the tillage implement 10 includes a tilt cylinder 46 (e.g., frame force cylinder) coupled to the hitch frame 16 of the hitch assembly 14 and to the main frame 12. The tilt cylinder 46 is configured to apply a tilt force (e.g., frame force) to the main frame 12, thereby urging the main frame 12 toward the surface of the field. Accordingly, the disc blades 36 and the rolling basket 44 may be driven into the soil. In the illustrated embodiment, the tilt cylinder 46 is a hydraulic cylinder. While the tillage implement 10 includes a single tilt cylinder 46 in the illustrated embodiment, in other embodiments, the tillage implement may include additional tilt cylinder(s) (e.g., 1, 2, 3, 4, or more additional tilt cylinder(s)).

Furthermore, in the illustrated embodiment, the tillage implement 10 includes one or more wheel frame actuators 48, in which each wheel frame actuator 48 is coupled to the wheel frame 24 and to the hitch frame 16 of the hitch assembly 14. Each wheel frame actuator 48 is configured to control the position of the wheels 26 relative to the hitch frame 16, thereby controlling the position of the pivot joint(s) 20 relative to the surface of the field. As a result, the wheel frame actuators 48 are configured to control the height of the main frame 12 (e.g., at least a front portion of the main frame 12) relative to the surface of the field, thereby controlling the penetration depth of the disc blades 36 (e.g., at least the front row 38 of disc blades 36) into the soil. Each wheel frame actuator 48 may include any suitable type of actuator, such as a hydraulic cylinder, a pneumatic cylinder, an electric linear actuator, a hydraulic motor, a pneumatic motor, an electric motor, etc. Furthermore, while the tillage implement 10 includes two wheel frame actuators 48 in the illustrated embodiment, in other embodiments, the tillage implement may include more or fewer wheel frame actuators (e.g., 1, 3, 4, 5, 6, or more).

In addition, in the illustrated embodiment, the tillage implement 10 includes one or more rolling basket cylinders 50 (e.g., gauge device cylinders), in which each rolling basket cylinder 50 is coupled to the main frame 12 and to the rolling basket frame 42. In the illustrated embodiment, each rolling basket cylinder 50 is a hydraulic cylinder. Furthermore, in the illustrated embodiment, the tillage implement 10 includes one rolling basket cylinder 50 for each section of the rolling basket frame 42. However, in other embodiments, the tillage implement may include multiple rolling basket cylinders for at least one rolling basket frame section (e.g., 2, 3, 4, or more). Furthermore, in embodiments in which the rolling basket frame has a single section, the tillage implement may include any suitable number of rolling basket cylinders for the single section (e.g., 1, 2, 3, 4, or more). The penetration depth of the disc blades 36 may be adjusted by controlling the extension of the wheel frame actuator(s) 48 and the extension of the rolling basket cylinder(s) 50.

As discussed in detail below, the tillage implement 10 includes a hydraulic control system configured to control the force applied by the tilt cylinder based on a force applied to the rolling basket cylinder(s) 50. In certain embodiments, the hydraulic control system includes a hydraulic circuit configured to receive hydraulic fluid from a first end of a rolling basket cylinder 50. In addition, the hydraulic circuit is configured to control a pressure of the hydraulic fluid within a first end of the tilt cylinder 46 based on the pressure of the hydraulic fluid within the first end of the rolling basket cylinder 50. For example, if the pressure of the hydraulic fluid within the first end of the rolling basket cylinder 50 decreases, the hydraulic circuit may automatically increase the pressure of the hydraulic fluid within the first end of the tilt cylinder 46, thereby increasing the tilt force applied to the main frame 12. In addition, if the pressure of the hydraulic fluid within the first end of the rolling basket cylinder 50 increases, the hydraulic circuit may automatically decrease the pressure of the hydraulic fluid within the first end of the tilt cylinder 46, thereby decreasing the tilt force applied to the main frame 12. By controlling the pressure of the hydraulic fluid within the first end of the tilt cylinder 46 based on the pressure of the hydraulic fluid within the first end of the rolling basket cylinder 50, the rolling basket 44 and the wheels 26 may maintain contact with the soil as the tillage implement 10 is towed along the field in the direction of travel 22 (e.g., as the tillage implement 10 encounters bumpy terrain), thereby substantially maintaining the penetration depth of the disc blades 36. As a result, the disc blades 36 of the tillage implement 10 may break up the top layer of the soil at a consistent depth, thereby enhancing the effectiveness of tillage operations.

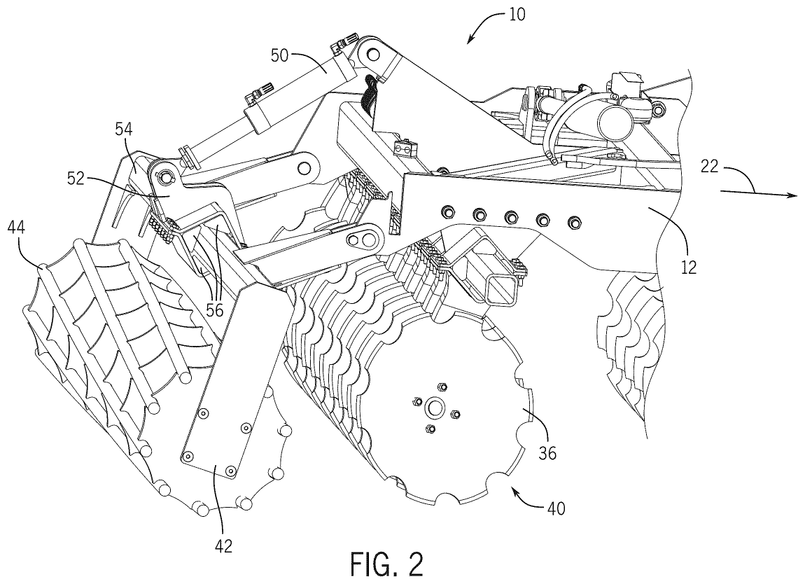

FIG. 2 is a perspective view of a portion of the tillage implement 10 of FIG. 1. As previously discussed, the rolling basket frame 42 is pivotally coupled to the main frame 12, and the rolling basket 44 is rotatably coupled to the rolling basket frame 42. As the tillage implement 10 is towed through the field along the direction of travel 22, the rolling basket 44 is driven to rotate, thereby sizing soil clods, leveling the soil surface, smoothing the soil surface, or a combination thereof. Furthermore, the rolling basket cylinder(s) 50 are coupled to the main frame 12 and to the rolling basket frame 42.

In the illustrated embodiment, each rolling basket cylinder 50 is pivotally coupled to a respective mount 52, and each mount 52 is disposed about a frame member 54 (e.g., a respective frame member, a common frame member, etc.) of the rolling basket frame 42. Furthermore, in the illustrated embodiment, resilient elements 56 are disposed between the mount 52 and the frame member 54 of the rolling basket frame 42. Accordingly, the rolling basket cylinder 50 is coupled to the rolling basket frame 42 via the mount 52 and the resilient elements 56. The resilient elements 56 are configured to enable the rolling basket frame 42 to rotate relative to the mount 52 and to urge the rolling basket frame 42 to rotate toward the illustrated undeflected position, which corresponds to an undeflected angle of the rolling basket frame 42 relative to the mount 52. During operation of the tillage implement 10, the rolling basket 44 is engaged with the soil, which may drive the rolling basket frame 42 to rotate relative to the mount 52 against the torque applied by the resilient elements 56. Accordingly, the resilient elements 56 may apply a torque to the rolling basket frame 42 while the rolling basket 44 is engaged with the soil. The downforce applied by the rolling basket 44 to the soil is based on the torque applied by the resilient elements 56 to the rolling basket frame 42, and the torque applied by the resilient elements 56 to the rolling basket frame 42 is based on the angular offset of the rolling basket frame 42 with respect to the illustrated undeflected position. Furthermore, the angular offset of the rolling basket frame 42 with respect to the undeflected position (e.g., with respect to the undeflected angle of the rolling basket frame 42 relative to the mount 52) is based on the angle of the rolling basket frame 42 relative to the main frame 12 and the extension of the rolling basket cylinder 50. The extension of the rolling basket cylinder 50 is adjustable, but may remain fixed/constant as the angular offset of the rolling basket frame 42 varies.

In the illustrated embodiment, four resilient elements 56 are disposed between the mount 52 and the frame member 54 of the rolling basket frame 42. However, in other embodiments, more or fewer resilient elements may be disposed between the mount and the frame member of the rolling basket frame (e.g., 1, 2, 3, 5, 6, or more). Furthermore, while resilient elements are configured to enable the rolling basket frame 42 to rotate relative to the mount 52 and to urge the rolling basket frame 42 to rotate toward the undeflected position in the illustrated embodiment, in other embodiments, other suitable element(s)/device(s) may be used to enable rotation of the rolling basket frame relative to the mount and to urge the rolling basket frame to rotate toward the undeflected position. For example, in certain embodiments, the rolling basket frame may be pivotally coupled to the mount, and a biasing element, such as a spring (e.g., coil spring, leaf spring, etc.), a pneumatic cylinder, etc., may urge the rolling basket frame to rotate toward the undeflected position. In addition, in embodiments in which the tillage implement includes multiple rolling basket cylinders for the rolling basket frame section, each rolling basket cylinder may be pivotally coupled to a respective mount (e.g., disposed about the frame member). Furthermore, in certain embodiments, the rolling basket cylinder (e.g., each rolling basket cylinder) may be directly pivotally coupled to the rolling basket frame (e.g., the tillage implement may not include any element(s)/device(s) configured to urge the rolling basket frame to rotate relative to the rolling basket cylinder(s)). While one section of the rolling basket frame 42 and one section of the rolling basket 44 are shown in FIG. 2 and discussed above, the structures and variations disclosed above may be applied to the other section(s) of the rolling basket frame/rolling basket. For example, in certain embodiments, a mount may be disposed about a frame member of another section of the rolling basket frame, a rolling basket cylinder may be pivotally coupled to the mount, and resilient elements may be disposed between the mount and the frame member.

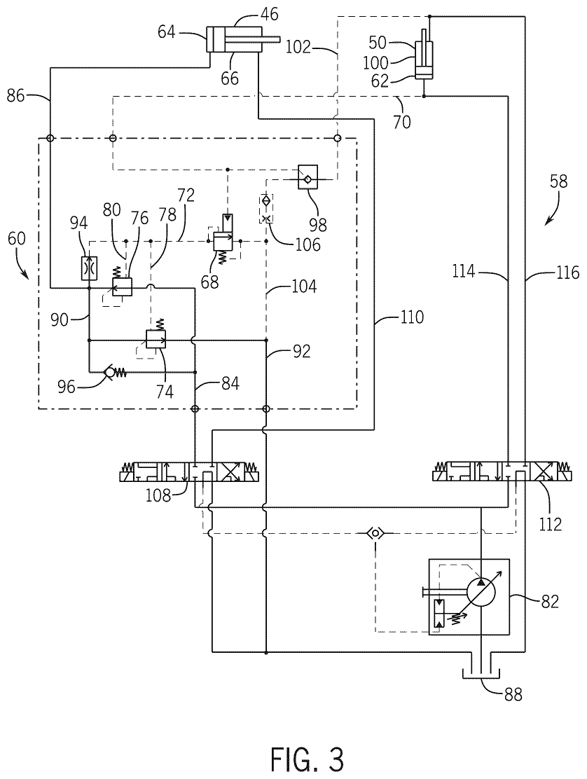

FIG. 3 is a schematic diagram of an embodiment of a hydraulic control system 58 that may be employed within the tillage implement 10 of FIG. 1. As discussed in detail below, the hydraulic control system 58 includes a hydraulic circuit 60 fluidly coupled to the tilt cylinder 46 and to the rolling basket cylinder 50. In the illustrated embodiment, the rolling basket cylinder 50 is arranged such that extension of the piston rod drives the mount to move downwardly relative to the main frame, and retraction of the piston rod drives the mount to move upwardly relative to the main frame. With the fluid flow to and from the rolling basket cylinder 50 blocked (e.g., such that the extension of the rolling basket cylinder 50 is fixed/constant), the contact force between the rolling basket and the soil (e.g., downforce) may drive the rolling basket frame to rotate with respect to the undeflected position. As a result, the resilient elements may establish a torque between the rolling basket frame and the mount, thereby urging the mount to rotate. However, rotation of the mount is blocked by the rolling basket cylinder 50, thereby establishing fluid pressure within the cap end 62 (e.g., first end) of the rolling basket cylinder 50. Accordingly, in the illustrated embodiment, the hydraulic circuit 60 is configured to monitor the pressure of the hydraulic fluid within the cap end 62 (e.g., first end) of the rolling basket cylinder 50. The pressure of the hydraulic fluid within the cap end 62 of the rolling basket cylinder 50 is based on the torque applied by the resilient elements. In certain embodiments, the rolling basket cylinder may be arranged such that extension of the piston rod drives the mount to move upwardly relative to the main frame, and retraction of the piston rod drives the mount to move downwardly relative to the main frame. In such embodiments, the hydraulic circuit is configured to monitor the pressure of the hydraulic fluid within the rod end (e.g., first end) of the rolling basket cylinder.

In the illustrated embodiment, the tilt cylinder 46 is arranged such that a higher fluid pressure at a cap end 64 (e.g., first end) causes the tilt cylinder 46 to apply a downward tilt/frame force to the main frame, thereby causing the disc blades to apply a downforce to the soil greater than the downforce caused by the weight of the main frame and the components coupled to the main frame. Furthermore, a higher fluid pressure at a rod end 66 (e.g., second end) of the tilt cylinder 46 causes the tilt cylinder to apply an upward tilt/frame force on the main frame, thereby causing the disc blades to apply a downforce to the soil less than the downforce caused by the weight of the main frame and the components coupled to the main frame. In the illustrated embodiment, the hydraulic circuit 60 is configured to control the pressure of the hydraulic fluid within the cap end 64 (e.g., first end) of the tilt cylinder 46 to control the downward tilt/frame force on the main frame. In certain embodiments, the tilt cylinder may be arranged such that a higher fluid pressure at the rod end (e.g., first end) causes the tilt cylinder to apply a downward tilt/frame force to the main frame, and a higher fluid pressure at the cap end (e.g., second end) of the tilt cylinder causes the tilt cylinder to apply an upward tilt/frame force to the main frame. In such embodiments, the hydraulic circuit is configured to control the pressure of the hydraulic fluid within the rod end (e.g., first end) of the tilt cylinder to control the downward tilt/frame force on the main frame.

In the illustrated embodiment, the hydraulic circuit 60 is configured to receive the hydraulic fluid from the cap end 62 (e.g., first end) of the rolling basket cylinder 50. In addition, the hydraulic circuit 60 is configured to control the pressure of the hydraulic fluid within the cap end 64 (e.g., first end) of the tilt cylinder 46 based on the pressure of the hydraulic fluid within the cap end 62 (e.g., first end) of the rolling basket cylinder 50. For example, if the pressure of the hydraulic fluid within the cap end 62 of the rolling basket cylinder 50 decreases, the hydraulic circuit 60 may automatically increase the pressure of the hydraulic fluid within the cap end 64 of the tilt cylinder 46, thereby increasing the downward tilt force applied to the main frame. In addition, if the pressure of the hydraulic fluid within the cap end 62 of the rolling basket cylinder 50 increases, the hydraulic circuit 60 may automatically decrease the pressure of the hydraulic fluid within the cap end 64 of the tilt cylinder 46, thereby decreasing the downward tilt force applied to the main frame. By controlling the pressure of the hydraulic fluid within the cap end 64 of the tilt cylinder 46 based on the pressure of the hydraulic fluid within the cap end 62 of the rolling basket cylinder 50, the rolling basket and the wheels may maintain contact with the soil as the tillage implement is towed along the field in the direction of travel (e.g., as the tillage implement encounters bumpy terrain), thereby substantially maintaining the penetration depth of the disc blades. As a result, the disc blades of the tillage implement may break up the top layer of the soil at a consistent depth, thereby enhancing the effectiveness of tillage operations.

In the illustrated embodiment, the hydraulic circuit 60 includes a first unloading valve 68 (e.g., unloading valve) fluidly coupled to the cap end 62 (e.g., first end) of the rolling basket cylinder 50 via a first pilot line 70. The first unloading valve 68 is configured to receive the hydraulic fluid from the cap end 62 (e.g., first end) of the rolling basket cylinder 50. In addition, the first unloading valve 68 is configured to control the pressure of the hydraulic fluid within the cap end 64 (e.g., first end) of the tilt cylinder 46 based on the pressure of the hydraulic fluid within the cap end 62 (e.g., first end) of the rolling basket cylinder 50. In the illustrated embodiment, the first unloading valve 68 includes an unloading relief valve configured to receive the hydraulic fluid from the cap end 62 (e.g., first end) of the rolling basket cylinder 50 via the first pilot line 70 and the hydraulic fluid from the cap end 64 (e.g., first end) of the tilt cylinder 46 via a second pilot line 72. The unloading relief valve is configured to relieve the pressure of the hydraulic fluid within the cap end 64 (e.g., first end) of the tilt cylinder 46 in response to the sum of the pressure of the hydraulic fluid within the cap end 62 of the rolling basket cylinder 50 and the pressure of the hydraulic fluid within the cap end 64 of the tilt cylinder 46 exceeding a threshold value. The unloading relief valve is also configured to increase the pressure of the hydraulic fluid within the cap end 64 (e.g., first end) of the tilt cylinder 46 in response to the sum of the pressure of the hydraulic fluid within the cap end 62 of the rolling basket cylinder 50 and the pressure of the hydraulic fluid within the cap end 64 of the tilt cylinder 46 being below the threshold value. The threshold value may be established by selecting a force applied by a biasing element (e.g., spring, etc.) of the unloading relief valve. If the pressure of the hydraulic fluid within the cap end 62 of the rolling basket cylinder 50 increases, the unloading relief valve may relieve the pressure of the hydraulic fluid within the cap end 64 of the tilt cylinder 46, thereby decreasing the downward tilt force applied to the main frame. Furthermore, if the pressure of the hydraulic fluid within the cap end 62 of the rolling basket cylinder 50 decreases, the unloading relief valve may increase the pressure of the hydraulic fluid within the cap end 64 of the tilt cylinder 46, thereby increasing the downward tilt force applied by the main frame.

With regard to the unloading relief valve disclosed above, the pressure of the hydraulic fluid within the cap end 62 of the rolling basket cylinder 50 and the pressure of the hydraulic fluid within the cap end 64 of the tilt cylinder 46 are unweighted in the sum of the pressures. Accordingly, the ratio of the pressure of the hydraulic fluid within the cap end 62 of the rolling basket cylinder 50 and the pressure of the hydraulic fluid within the cap end 64 of the tilt cylinder 46 is 1:1. However, in other embodiments, the unloading relief valve may utilize any other suitable ratio for the sum (e.g., by weighting one of the pressures), such as 1:2, 1:3, 2:1, 3:1, etc. Furthermore, in certain embodiments, the first unloading valve may include any other suitable type of unloading valve. For example, in certain embodiments, the first unloading valve may include a sequence valve configured to compare the pressure of the hydraulic fluid within the cap end of the rolling basket cylinder alone to a threshold value. Accordingly, the sequence valve is configured to relieve the pressure of the hydraulic fluid within the cap end (e.g., first end) of the tilt cylinder in response to the pressure of the hydraulic fluid within the cap end of the rolling basket cylinder exceeding a threshold value, and the sequence valve is configured to increase the pressure of the hydraulic fluid within the cap end (e.g., first end) of the tilt cylinder in response to the pressure of the hydraulic fluid within the cap end of the rolling basket cylinder being below the threshold value.

In the illustrated embodiment, the hydraulic circuit 60 includes a pressure relieving valve 74 (e.g., first pressure relieving valve) and a pressure reducing valve 76 (e.g., first pressure reducing valve). The pressure relieving valve 74 is fluidly coupled to the first unloading valve 68 via a third pilot line 78, and the pressure reducing valve 76 is fluidly coupled to the first unloading valve 68 via a fourth pilot line 80. Furthermore, the pressure reducing valve 76 is fluidly disposed between a fluid source 82 and the cap end 64 of the tilt cylinder 46. As illustrated, a first supply line 84 is fluidly coupled to the pressure reducing valve 76 and configured to receive hydraulic fluid from the fluid source 82, and a second supply line 86 extends from the pressure reducing valve 76 to the cap end 64 of the tilt cylinder 46. In addition, the pressure relieving valve 74 is fluidly disposed between the cap end 64 of the tilt cylinder 46 and a tank 88. As illustrated, a first return line 90 extends from the second supply line 86 to the pressure relieving valve 74, and a second return line 92 is fluidly coupled to the pressure relieving valve 74 and configured to provide hydraulic fluid to the tank 88.

The first unloading valve 68 is configured to control the pressure reducing valve 76 and the pressure relieving valve 74 to control the pressure of the hydraulic fluid within the cap end 64 of the tilt cylinder 46. For example, in response to the sum of the pressure of the hydraulic fluid within the cap end 62 of the rolling basket cylinder 50 and the pressure of the hydraulic fluid within the cap end 64 of the tilt cylinder 46 exceeding the threshold value, the first unloading valve 68 at least partially opens, thereby reducing the pressure of the hydraulic fluid within the second pilot line 72, the third pilot line 78, and the fourth pilot line 80. As a result, the pressure reducing valve 76 may increase the pressure reduction between the first supply line 84 and the second supply line 86, thereby reducing or eliminating the pressure of the hydraulic fluid provided by the fluid source 82 to the cap end 64 of the tilt cylinder 46. In addition, the pressure relieving valve 74 may increase the pressure relief between the first return line 90 and the second return line 92, thereby reducing the pressure of the hydraulic fluid within the cap end 64 of the tilt cylinder 46. Furthermore, in response to the sum of the pressure of the hydraulic fluid within the cap end 62 of the rolling basket cylinder 50 and the pressure of the hydraulic fluid within the cap end 64 of the tilt cylinder 46 being below the threshold value, the first unloading valve 68 at least partially closes, thereby increasing the pressure of the hydraulic fluid within the second pilot line 72, the third pilot line 78, and the fourth pilot line 80. As a result, the pressure reducing valve 76 may reduce the pressure reduction between the first supply line 84 and the second supply line 86, thereby increasing the pressure of the hydraulic fluid provided by the fluid source 82 to the cap end 64 of the tilt cylinder 46. In addition, the pressure relieving valve 74 may reduce or eliminate the pressure relief between the first return line 90 and the second return line 92, thereby increasing the pressure of the hydraulic fluid within the cap end 64 of the tilt cylinder 46. While the first unloading valve 68 is configured to control the pressure reducing valve 76 and the pressure relieving valve 74 in the illustrated embodiment, in other embodiments, the first unloading valve may be configured to control other and/or additional suitable valves to control the pressure of the hydraulic fluid within the cap end of the tilt cylinder. For example, in certain embodiments, at least one of the pressure reducing valve or the pressure relieving valve may be omitted.

In the illustrated embodiment, the hydraulic circuit 60 includes a flow control valve 94 fluidly disposed between the second supply line 86 and the second pilot line 72. The flow control valve 94 is configured to control hydraulic fluid flow from the second supply line 86 to the second pilot line 72. For example, the flow control valve 94 may substantially reduce the flow rate of the hydraulic fluid from the second supply line 86 to the second pilot line 72. Furthermore, in the illustrated embodiment, the hydraulic circuit 60 includes a check valve 96 fluidly disposed between the first supply line 84 and the first return line 90. The check valve 96 is configured to enable fluid flow from the first return line 90 to the first supply line 84 only while the pressure of the hydraulic fluid within the first return line 90 is greater than the pressure of the hydraulic fluid within the first supply line 84 by more than a threshold value (e.g., established by a spring of the check valve 96). In addition, the check valve 96 is configured to block flow of the hydraulic fluid from the first supply line 84 to the first return line 90. While the hydraulic circuit includes the flow control valve 94 and the check valve 96 in the illustrated embodiment, in other embodiments, at least one of the flow control valve or the check valve may be omitted. Furthermore, in certain embodiments, the hydraulic circuit may include other suitable valve(s).

In the illustrated embodiment, the hydraulic circuit 60 includes a pilot operated check valve 98 fluidly coupled to a rod end 100 (e.g., second end) of the rolling basket cylinder 50 via a fifth pilot line 102. The pilot operated check valve 98 is also fluidly coupled to the tank 88 via a sixth pilot line 104 and the second return line 92. The pilot operated check valve 98 is configured to open based on the pressure of the hydraulic fluid within the cap end 62 (e.g., first end) of the rolling basket cylinder 50. As illustrated, the pilot operated check valve 98 is fluidly coupled to the cap end 62 of the rolling basket cylinder 50 via the first pilot line 70. The pilot operated check valve 98 is configured to enhance the ability of the first unloading valve 68 to monitor the pressure of the hydraulic fluid within the cap end 62 of the rolling basket cylinder 50. For example, in response to the pressure of the hydraulic fluid within the cap end 62 of the rolling basket cylinder 50 increasing due to the contact force between the rolling basket and the soil, the pilot operated check valve 98 may be driven to open, thereby enabling the hydraulic fluid within the rod end 100 of the rolling basket cylinder 50 to drain to the tank 88 via the fifth pilot line 102, the sixth pilot line 104, and the second return line 92, thereby substantially reducing or eliminating residual pressure of the hydraulic fluid within the rod end 100 of the rolling basket cylinder 50. As a result, the first unloading valve 68 may monitor the pressure of the hydraulic fluid within the cap end 62 of the rolling basket cylinder 50 without interference or with reduced interference from the hydraulic fluid within the rod end 100 of the rolling basket cylinder 50.

In the illustrated embodiment, the hydraulic circuit 60 includes an orifice valve 106 disposed along the sixth pilot line 104 downstream from the pilot operated check valve 98. The orifice valve 106 is configured to control flow of the hydraulic fluid from the pilot operated check valve 98 to the tank 88. For example, the orifice valve 106 may reduce the flow rate of the hydraulic fluid from the pilot operated check valve 98 to the tank 88. While the hydraulic circuit 60 includes the pilot operated check valve 98 and the orifice valve 106 in the illustrated embodiment, in other embodiments, the orifice valve may be omitted, or the pilot operated check valve and the orifice valve may be omitted.

In the illustrated embodiment, the hydraulic control system 58 includes a tilt cylinder control valve 108. The tilt cylinder control valve 108 is fluidly coupled to the cap end 64 of the tilt cylinder 46 via the first supply line 84 and the second supply line 86. In addition, the tilt cylinder control valve 108 is fluidly coupled to the rod end 66 of the tilt cylinder 46 via a third return line 110. The tilt cylinder control valve 108 is also fluidly coupled to the fluid source 82 and to the tank 88. The tilt cylinder control valve 108 is configured to selectively establish a connection between the first supply line 84 and the fluid source 82 and a connection between the third return line 110 and the tank 88. During operation of the agricultural implement within the field, the tilt cylinder control valve 108 may establish the connection between the first supply line 84 and the fluid source 82 and the connection between the third return line 110 and the tank 88, thereby enabling the hydraulic circuit 60 to control the pressure of the hydraulic fluid within the cap end 64 of the tilt cylinder 46 based on the pressure of the hydraulic fluid within the cap end 62 of the rolling basket cylinder 50. The tilt cylinder control valve 108 may be manually controlled or automatically controlled (e.g., via a controller communicatively coupled to the tilt cylinder control valve).

Furthermore, in the illustrated embodiment, the hydraulic control system 58 includes a rolling basket cylinder control valve 112. The rolling basket cylinder control valve 112 is fluidly coupled to the cap end 62 of the rolling basket cylinder 50 via a third supply line 114, and the rolling basket cylinder control valve 112 is fluidly coupled to the rod end 100 of the rolling basket cylinder 50 via a fourth return line 116. The rolling basket cylinder control valve 112 is also fluidly coupled to the fluid source 82 and to the tank 88. The rolling basket cylinder control valve 112 is configured to control fluid flow to the cap end 62 and to the rod end 100 of the rolling basket cylinder 50 to control extension and retraction of the piston rod of the rolling basket cylinder 50. In addition, the rolling basket cylinder control valve 112 is configured to block fluid flow between the fluid source 82 and the rolling basket cylinder 50 and to block fluid flow between the rolling basket cylinder 50 and the tank 88. During operation of the agricultural implement within the field, the rolling basket cylinder control valve 112 may block fluid flow between the fluid source 82 and the rolling basket cylinder 50 and block fluid flow between the rolling basket cylinder 50 and the tank 88, thereby enabling the hydraulic circuit 60 to control the pressure of the hydraulic fluid within the cap end 64 of the tilt cylinder 46 based on the pressure of the hydraulic fluid within the cap end 62 of the rolling basket cylinder 50. The rolling basket cylinder control valve 112 may be manually controlled or automatically controlled (e.g., via a controller communicatively coupled to the rolling basket cylinder control valve).

In the illustrated embodiment, the agricultural implement includes a single tilt cylinder 46. However, in other embodiments, the agricultural implement may include multiple tilt cylinders fluidly coupled to one another in a parallel arrangement. In such embodiments, the second supply line may be fluidly coupled to the cap end (e.g., first end) of each tilt cylinder, and the third return line may be fluidly coupled to the rod end (e.g., second end) of each tilt cylinder.

In the illustrated embodiment, the agricultural implement includes a single rolling basket cylinder 50. However, in other embodiments, the agricultural implement may include multiple rolling basket cylinders (e.g., one rolling basket cylinder for each rolling basket frame section, etc.) fluidly coupled to one another in a serial arrangement (e.g., to provide substantially equal extension and retraction of the piston rods of the rolling basket cylinders). In such embodiments, the first pilot line and the third supply line may be fluidly coupled to the cap end (e.g., first end) of the first rolling basket cylinder in the series, and the fifth pilot line and the fourth return line may be fluidly coupled to the rod end (e.g., second end) of the last rolling basket cylinder in the series. In certain embodiments, each rolling basket cylinder may be a rephasing cylinder to facilitate coordinated movement of the piston rods of the rolling basket cylinders. With regard to embodiments including multiple rolling basket cylinders in a serial arrangement, references to “the cap/first end of the rolling basket cylinder” above refer to the cap/first end of the first rolling basket cylinder in the series, and references to “the rod/second end of the rolling basket cylinder” above refer to the rod/second end of the last rolling basket cylinder in the series.

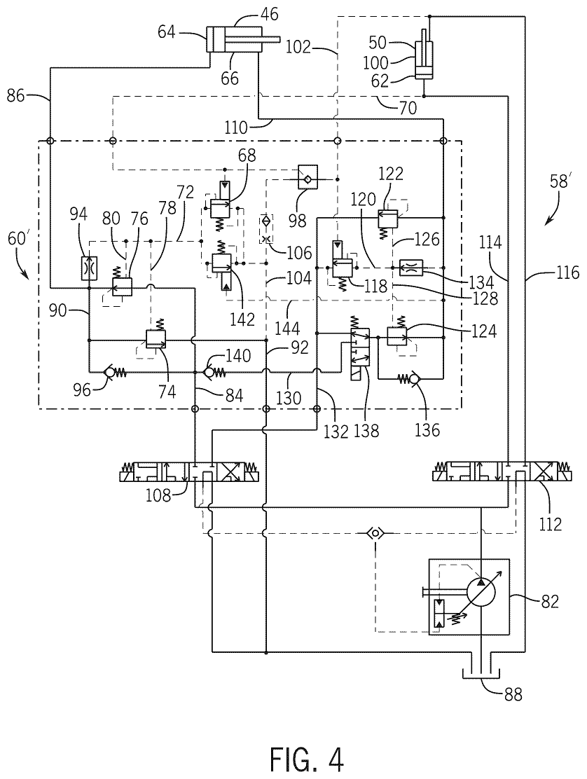

FIG. 4 is a schematic diagram of another embodiment of a hydraulic control system 58′ that may be employed within the tillage implement of FIG. 1. The configuration of the hydraulic control system 58′ corresponds to the configuration of the hydraulic control system 58 disclosed above with reference to FIG. 3 except for the differences disclosed below. Accordingly, the features and variations disclosed above with regard to the hydraulic control system 58 of FIG. 3 apply to the hydraulic control system 58′ disclosed below.

In the illustrated embodiment, the hydraulic circuit 60′ is configured to control a pressure of the hydraulic fluid within the rod end 66 (e.g., second end) of the tilt cylinder 46 based on a pressure of the hydraulic fluid within the rod end 100 (e.g., second end) of the rolling basket cylinder 50. For example, in certain field conditions (e.g., muddy soil), the tilt cylinder 46 may apply an upward tilt force (e.g., frame force) to the main frame, thereby urging the main frame away from the surface of the field. As a result, the disc blades may apply a downforce to the soil less than the downforce caused by the weight of the main frame and the components coupled to the main frame. In addition, the downforce applied by the disc blades to the soil combined with the upward tilt force applied by the tilt cylinder 46 to the main frame may be sufficient to cause the contact force between the rolling basket and the soil to be less than the contact force due to the weight of the rolling basket frame and the components coupled to the rolling basket frame. As a result, a portion of the weight of the rolling basket frame and the components coupled to the rolling basket frame is applied to the rolling basket cylinder 50, which increases the pressure of the hydraulic fluid within the rod end 100 (e.g., second end) of the rolling basket cylinder 50. Accordingly, in the illustrated embodiment, the hydraulic circuit 60′ is configured to monitor the pressure of the hydraulic fluid within the rod end 100 (e.g., second end) of the rolling basket cylinder 50. As previously discussed, in certain embodiments, the rolling basket cylinder may be arranged such that extension of the piston rod drives the mount to move upwardly relative to the main frame, and retraction of the piston rod drives the mount to move downwardly relative to the main frame. In such embodiments, the hydraulic circuit is configured to monitor the pressure of the hydraulic fluid within the cap end (e.g., second end) of the rolling basket cylinder.

In the illustrated embodiment, the hydraulic circuit 60′ is configured to receive the hydraulic fluid from the rod end 100 (e.g., second end) of the rolling basket cylinder 50. In addition, the hydraulic circuit 60′ is configured to control the pressure of the hydraulic fluid within the rod end 66 (e.g., second end) of the tilt cylinder 46 based on the pressure of the hydraulic fluid within the rod end 100 (e.g., second end) of the rolling basket cylinder 50. For example, if the pressure of the hydraulic fluid within the rod end 100 of the rolling basket cylinder 50 decreases, the hydraulic circuit 60′ may automatically increase the pressure of the hydraulic fluid within the rod end 66 of the tilt cylinder 46, thereby increasing the upward tilt force applied to the main frame. In addition, if the pressure of the hydraulic fluid within the rod end 100 of the rolling basket cylinder 50 increases, the hydraulic circuit 60′ may automatically decrease the pressure of the hydraulic fluid within the rod end 66 of the tilt cylinder 46, thereby decreasing the upward tilt force applied to the main frame. By controlling the pressure of the hydraulic fluid within the rod end 66 of the tilt cylinder 46 based on the pressure of the hydraulic fluid within the rod end 100 of the rolling basket cylinder 50, the contact force between the rolling basket and the soil may be substantially maintained as the tillage implement is towed along the field in the direction of travel. As a result, the possibility of disengaging the rolling basket from the soil is substantially reduced or eliminated, thereby substantially maintaining the penetration depth of the disc blades.

In the illustrated embodiment, the hydraulic circuit 60′ includes a second unloading valve 118 (e.g., unloading valve) fluidly coupled to the rod end 100 (e.g., second end) of the rolling basket cylinder 50 via the fifth pilot line 102. The second unloading valve 118 is configured to receive the hydraulic fluid from the rod end 100 (e.g., second end) of the rolling basket cylinder 50. In addition, the second unloading valve 118 is configured to control the pressure of the hydraulic fluid within the rod end 66 (e.g., second end) of the tilt cylinder 46 based on the pressure of the hydraulic fluid within the rod end 100 (e.g., second end) of the rolling basket cylinder 50. In the illustrated embodiment, the second unloading valve 118 includes an unloading relief valve configured to receive the hydraulic fluid from the rod end 100 (e.g., second end) of the rolling basket cylinder 50 via the fifth pilot line 102 and the hydraulic fluid from the rod end 66 (e.g., second end) of the tilt cylinder 46 via the third return line 110 and a seventh pilot line 120. The unloading relief valve is configured to relieve the pressure of the hydraulic fluid within the rod end 66 (e.g., second end) of the tilt cylinder 46 in response to the sum of the pressure of the hydraulic fluid within the rod end 100 of the rolling basket cylinder 50 and the pressure of the hydraulic fluid within the rod end 66 of the tilt cylinder 46 exceeding a threshold value. The unloading relief valve is also configured to increase the pressure of the hydraulic fluid within the rod end 66 (e.g., second end) of the tilt cylinder 46 in response to the sum of the pressure of the hydraulic fluid within the rod end 100 of the rolling basket cylinder 50 and the pressure of the hydraulic fluid within the rod end 66 of the tilt cylinder 46 being below the threshold value. The threshold value may be established by selecting a force applied by a biasing element (e.g., spring, etc.) of the unloading relief valve. For example, if the pressure of the hydraulic fluid within the rod end 100 of the rolling basket cylinder 50 increases, the unloading relief valve may relieve the pressure of the hydraulic fluid within the rod end 66 of the tilt cylinder 46, thereby decreasing the upward tilt force applied to the main frame. As a result, the rolling basket may maintain contact with the soil, thereby enabling the rolling basket to control the penetration depth of the disc blades. In addition, if the pressure of the hydraulic fluid within the rod end 100 of the rolling basket cylinder 50 decreases, the unloading relief valve may increase the pressure of the hydraulic fluid within the rod end 66 of the tilt cylinder 46, thereby increasing the upward tilt force applied to the main frame.

With regard to the unloading relief valve disclosed above, the pressure of the hydraulic fluid within the rod end 100 of the rolling basket cylinder 50 and the pressure of the hydraulic fluid within the rod end 66 of the tilt cylinder 46 are unweighted in the sum of the pressures. Accordingly, the ratio of the pressure of the hydraulic fluid within the rod end 100 of the rolling basket cylinder 50 and the pressure of the hydraulic fluid within the rod end 66 of the tilt cylinder 46 is 1:1. However, in other embodiments, the unloading relief valve may utilize any other suitable ratio for the sum (e.g., by weighting one of the pressures), such as 1:2, 1:3, 2:1, 3:1, etc. Furthermore, in certain embodiments, the second unloading valve may include any other suitable type of unloading valve. For example, in certain embodiments, the second unloading valve may include a sequence valve configured to compare the pressure of the hydraulic fluid within the rod end of the rolling basket cylinder alone to a threshold value. Accordingly, the sequence valve is configured to relieve the pressure of the hydraulic fluid within the rod end (e.g., second end) of the tilt cylinder in response to the pressure of the hydraulic fluid within the rod end of the rolling basket cylinder exceeding a threshold value, and the sequence valve is configured to increase the pressure of the hydraulic fluid within the rod end (e.g., second end) of the tilt cylinder in response to the pressure of the hydraulic fluid within the rod end of the rolling basket cylinder being below the threshold value.

In the illustrated embodiment, the hydraulic circuit 60′ includes a second pressure relieving valve 122 and a second pressure reducing valve 124. The second pressure relieving valve 122 is fluidly coupled to the second unloading valve 118 via an eighth pilot line 126 and the seventh pilot line 120, and the second pressure reducing valve 124 is fluidly coupled to the second unloading valve 118 via a ninth pilot line 128 and the seventh pilot line 120. Furthermore, the second pressure reducing valve 124 is fluidly disposed between the fluid source 82 and the rod end 66 of the tilt cylinder 46. As illustrated, a fourth supply line 130 is fluidly coupled to the second pressure reducing valve 124 and configured to receive hydraulic fluid from the fluid source 82, and the third return line 110 is configured to receive the hydraulic fluid from the second pressure reducing valve 124 and to provide the hydraulic fluid to the rod end 66 of the tilt cylinder 46. In addition, the second pressure relieving valve 122 is fluidly disposed between the rod end 66 of the tilt cylinder 46 and the tank 88. As illustrated, the third return line 110 is configured to provide hydraulic fluid from the rod end 66 of the tilt cylinder 46 to the second pressure relieving valve 122, and a fifth return line 132 is fluidly coupled to the second pressure relieving valve 122 and configured to provide the hydraulic fluid to the tank 88. In the illustrated embodiment, the fifth return line 132 is fluidly coupled to the tilt cylinder control valve 108, as compared to the third return line as disclosed above with regard to the hydraulic control system of FIG. 3.

The second unloading valve 118 is configured to control the second pressure reducing valve 124 and the second pressure relieving valve 122 to control the pressure of the hydraulic fluid within the rod end 66 of the tilt cylinder 46. For example, in response to the sum of the pressure of the hydraulic fluid within the rod end 100 of the rolling basket cylinder 50 and the pressure of the hydraulic fluid within the rod end 66 of the tilt cylinder 46 exceeding the threshold value, the second unloading valve 118 at least partially opens, thereby reducing the pressure of the hydraulic fluid within the seventh pilot line 120, the eighth pilot line 126, and the ninth pilot line 128. As a result, the second pressure reducing valve 124 may increase the pressure reduction between the fourth supply line 130 and the third return line 110, thereby reducing or eliminating the pressure of the hydraulic fluid provided by the fluid source 82 to the rod end 66 of the tilt cylinder 46. In addition, the second pressure relieving valve 122 may increase the pressure relief between the third return line 110 and the fifth return line 132, thereby reducing the pressure of the hydraulic fluid within the rod end 66 of the tilt cylinder 46. Furthermore, in response to the sum of the pressure of the hydraulic fluid within the rod end 100 of the rolling basket cylinder 50 and the pressure of the hydraulic fluid within the rod end 66 of the tilt cylinder 46 being below the threshold value, the second unloading valve 118 at least partially closes, thereby increasing the pressure of the hydraulic fluid within the seventh pilot line 120, the eighth pilot line 126, and the ninth pilot line 128. As a result, the second pressure reducing valve 124 may decrease the pressure reduction between the fourth supply line 130 and the third return line 110, thereby increasing the pressure of the hydraulic fluid provided by the fluid source 82 to the rod end 66 of the tilt cylinder 46. In addition, the second pressure relieving valve 122 may decrease or eliminate the pressure relief between the third return line 110 and the fifth return line 132, thereby increasing the pressure of the hydraulic fluid within the rod end 66 of the tilt cylinder 46. While the second unloading valve 118 is configured to control the second pressure reducing valve 124 and the second pressure relieving valve 122 in the illustrated embodiment, in other embodiments, the second unloading valve may be configured to control other and/or additional suitable valves to control the pressure of the hydraulic fluid within the rod end of the tilt cylinder. For example, in certain embodiments, at least one of the second pressure reducing valve or the second pressure relieving valve may be omitted.

In the illustrated embodiment, the hydraulic circuit 60′ includes an activation valve 138 fluidly disposed between the fluid source 82 and the second pressure reducing valve 124. The activation valve 138 is configured to selectively block hydraulic fluid flow between the fluid source 82 and the second pressure reducing valve 124. As illustrated, the activation valve 138 is fluidly coupled to the fourth supply line 130 and to the fifth return line 132. While the activation valve 138 is open, the activation valve 138 facilitates hydraulic fluid flow from the fourth supply line 130 to the second pressure reducing valve 124. In addition, while the activation valve 138 is closed, the activation valve 138 blocks hydraulic fluid flow from the fourth supply line 130 to the second pressure reducing valve 124 and enables hydraulic fluid flow from the third return line 110 to the fifth return line 132. Accordingly, while open, the activation valve 138 enables the hydraulic circuit 60′ to control the pressure of the hydraulic fluid within the rod end 66 of the tilt cylinder 46 based on the pressure of the hydraulic fluid within the rod end 100 of the rolling basket cylinder 50. In addition, while closed, the activation valve 138 disables the hydraulic circuit 60′ from controlling the pressure of the hydraulic fluid within the rod end 66 of the tilt cylinder 46 based on the pressure of the hydraulic fluid within the rod end 100 of the rolling basket cylinder 50. The activation valve 138 may be manually controlled or automatically controlled (e.g., via a controller communicatively coupled to the activation valve). For example, the activation valve 138 may be manually or automatically opened for headland turns and closed for traversing swaths. Furthermore, while the hydraulic circuit 60′ includes the activation valve 138 in the illustrated embodiment, in other embodiments, the activation valve may be omitted (e.g., the fourth supply line may be fluidly coupled to the second pressure reducing valve).

In the illustrated embodiment, the hydraulic circuit 60′ includes a second flow control valve 134 fluidly disposed between the third return line 110 and the seventh pilot line 120. The second flow control valve 134 is configured to control hydraulic fluid flow from the third return line 110 to the seventh pilot line 120. For example, the second flow control valve 134 may substantially reduce the flow rate of the hydraulic fluid from the third return line 110 to the seventh pilot line 120. Furthermore, in the illustrated embodiment, the hydraulic circuit 60′ includes a second check valve 136 fluidly disposed between the fourth supply line 130 and the third return line 110. While the activation valve 138 is closed, the second check valve 136 is configured to enable fluid flow from the third return line 110 to the fifth return line 132 only while the pressure of the hydraulic fluid within the third return line 110 is greater than the pressure of the hydraulic fluid within the fifth return line 132 by more than a threshold value (e.g., established by a spring of the second check valve 136). In addition, while the activation valve 138 is open, the second check valve 136 is configured to block flow of the hydraulic fluid from the fourth supply line 130 to the third return line 110. While the hydraulic circuit includes the second flow control valve 134 and the second check valve 136 in the illustrated embodiment, in other embodiments, at least one of the second flow control valve or the second check valve may be omitted. Furthermore, in certain embodiments, the hydraulic circuit may include other suitable valve(s).

In the illustrated embodiment, the hydraulic circuit 60′ includes a third check valve 140 fluidly disposed between the first supply line 84 and the fourth supply line 130. The third check valve 140 is configured to enable fluid flow from the first supply line 84 to the fourth supply line 130 only while the pressure of the hydraulic fluid within the first supply line 84 is greater than the pressure of the hydraulic fluid within the fourth supply line by more than a threshold value (e.g., established by a spring of the third check valve 140). In addition, the third check valve 140 is configured to block flow of the hydraulic fluid from the fourth supply line 130 to the first supply line 84. While the hydraulic circuit includes the third check valve 140 in the illustrated embodiment, in other embodiments, the third check valve may be omitted.

In the illustrated embodiment, the hydraulic circuit 60′ includes a third unloading valve 142 fluidly coupled to the rod end 66 (e.g., second end) of the tilt cylinder 46 via a tenth pilot line 144 and the third return line 110. The third unloading valve 142 is configured to receive the hydraulic fluid from the rod end 66 of the tilt cylinder 46. In addition, the third unloading valve 142 is configured to control a pressure of the hydraulic fluid within the cap end 64 of the tilt cylinder 46 based on the pressure of the hydraulic fluid within the rod end 66 of the tilt cylinder 46. In the illustrated embodiment, the third unloading valve 142 includes an unloading relief valve configured to receive the hydraulic fluid from the rod end 66 (e.g., second end) of the tilt cylinder 46 and the hydraulic fluid from the cap end 64 (e.g., first end) of the tilt cylinder 46. The unloading relief valve is configured to relieve the pressure of the hydraulic fluid within the cap end 64 (e.g., first end) of the tilt cylinder 46 in response to the sum of the pressure of the hydraulic fluid within the rod end 66 of the tilt cylinder 46 and the pressure of the hydraulic fluid within the cap end 64 of the tilt cylinder 46 exceeding a threshold value. The unloading relief valve is also configured to increase the pressure of the hydraulic fluid within the cap end 64 (e.g., first end) of the tilt cylinder 46 in response to the sum of the pressure of the hydraulic fluid within the rod end 66 of the tilt cylinder 46 and the pressure of the hydraulic fluid within the cap end 64 of the tilt cylinder 46 being below the threshold value. The threshold value may be established by selecting a force applied by a biasing element (e.g., spring, etc.) of the unloading relief valve. For example, if the pressure of the hydraulic fluid within the rod end 66 of the tilt cylinder 46 increases, the unloading relief valve may relieve the pressure of the hydraulic fluid within the cap end 64 of the tilt cylinder 46, thereby decreasing the downward tilt force applied to the main frame.

With regard to the unloading relief valve disclosed above, the pressure of the hydraulic fluid within the rod end 66 of the tilt cylinder 46 and the pressure of the hydraulic fluid within the cap end 64 of the tilt cylinder 46 are unweighted in the sum of the pressures. Accordingly, the ratio of the pressure of the hydraulic fluid within the rod end 66 of the tilt cylinder 46 and the pressure of the hydraulic fluid within the cap end 64 of the tilt cylinder 46 is 1:1. However, in other embodiments, the unloading relief valve may utilize any other suitable ratio for the sum (e.g., by weighting one of the pressures), such as 1:2, 1:3, 2:1, 3:1, etc. Furthermore, in certain embodiments, the third unloading valve may include any other suitable type of unloading valve. For example, in certain embodiments, the third unloading valve may include a sequence valve configured to compare the pressure of the hydraulic fluid within the rod end of the tilt cylinder alone to a threshold value. Accordingly, the sequence valve is configured to relieve the pressure of the hydraulic fluid within the cap end (e.g., first end) of the tilt cylinder in response to the pressure of the hydraulic fluid within the rod end of the tilt cylinder exceeding a threshold value, and the sequence valve is configured to increase the pressure of the hydraulic fluid within the cap end (e.g., first end) of the tilt cylinder in response to the pressure of the hydraulic fluid within the rod end of the tilt cylinder being below the threshold value.

As illustrated, the first unloading valve 68 and the third unloading valve 142 are arranged in a parallel configuration. Accordingly, the first and third unloading valves are configured to control the pressure of the hydraulic fluid within the cap end 64 of the tilt cylinder 46 based on the pressure of the hydraulic fluid within the cap end 62 of the rolling basket cylinder 50 and the pressure of the hydraulic fluid within the rod end 66 of the tilt cylinder 46. For example, in response to the second unloading valve 118 increasing the pressure of the hydraulic fluid within the rod end 66 of the tilt cylinder 46, the sum of the pressure of the hydraulic fluid within the rod end 66 of the tilt cylinder 46 and the pressure of the hydraulic fluid within the cap end 64 of the tilt cylinder 46 may exceed the threshold value. As a result, the third unloading valve 142 may relieve the pressure of the hydraulic fluid within the cap end 64 of the tilt cylinder 46, thereby enabling the second unloading valve 118 to continue to increase the pressure of the hydraulic fluid within the rod end 66 of the tilt cylinder 46. As such, the third unloading valve 142 prioritizes control of the pressure of the hydraulic fluid within the rod end 66 (e.g., second end) of the tilt cylinder 46 over control of the pressure of the hydraulic fluid within the cap end 64 (e.g., first end) of the tilt cylinder, thereby enabling control of the pressure of the hydraulic fluid within both ends of the tilt cylinder to be performed concurrently. In addition, in response to the second unloading valve 118 reducing the pressure of the hydraulic fluid within the rod end 66 of the tilt cylinder 46, the sum of the pressure of the hydraulic fluid within the rod end 66 of the tilt cylinder 46 and the pressure of the hydraulic fluid within the cap end 64 of the tilt cylinder 46 may be below the threshold value. As a result, the third unloading valve 142 may not relieve the pressure of the hydraulic fluid within the cap end 64 of the tilt cylinder 46, thereby enabling the first unloading valve 68 to control the pressure of the hydraulic fluid within the cap end 64 of the tilt cylinder 46. While the hydraulic circuit 60′ includes the third unloading valve 142 in the illustrated embodiment, in other embodiments, the third unloading valve may be omitted.

While the tillage implement includes a rolling basket in the embodiments disclosed herein, in certain embodiments, the tillage implement may include other suitable type(s) of gauge device(s) (e.g., alone or in combination with the rolling basket), such as solid rubber roller(s), steel spring roller(s), gauge wheel(s), skid(s), etc. In such embodiments, the gauge device(s) are coupled to gauge device frame(s) that are movably (e.g., pivotally) coupled to the main frame, and gauge device cylinder(s) are coupled to the main frame and to the gauge device frame(s). Furthermore, while the tillage implement includes a tilt cylinder coupled to the main frame and to the hitch frame in the illustrated embodiment, in other embodiments, the tillage implement may include another suitable frame force cylinder configured to apply a frame force to the main frame, thereby urging the main frame toward the surface of the field. For example, in certain embodiments, the frame force cylinder may be coupled to the main frame (e.g., tool frame) and to a chassis of a self-propelled vehicle (e.g., in which the main frame is pivotally coupled to the chassis). Furthermore, in certain embodiments, the frame force cylinder may be coupled to the main frame (e.g., tool frame) and to a frame supported by wheels and/or tracks. In certain embodiments, the hydraulic circuit may control the pressure of the hydraulic fluid within the frame force cylinder based on the pressure of the hydraulic fluid within the gauge device cylinder, as disclosed above with reference to FIGS. 3-4 with regard to the tilt cylinder and the rolling basket cylinder.

In addition, while the embodiments above disclose a hydraulic control system employed within a tillage implement, in certain embodiments, the hydraulic control system disclosed herein may be employed within other suitable agricultural implements. For example, in certain embodiments, the hydraulic control system disclosed herein may be employed within an agricultural planter. The agricultural planter may include a tool frame (e.g., main frame, toolbar, etc.) and multiple planting row units coupled to the tool frame. In addition, the agricultural planter may include a frame force cylinder coupled to the tool frame and configured to apply a frame force to the tool frame. Furthermore, the agricultural planter may include a gauge device frame and a gauge device coupled to the gauged device frame. The agricultural planter may also include a gauge device cylinder coupled to the tool frame and to the gauge device frame. In certain embodiments, the hydraulic circuit may control the pressure of the hydraulic fluid within the frame force cylinder based on the pressure of the hydraulic fluid within the gauge device cylinder, as disclosed above with reference to FIGS. 3-4 with regard to the tilt cylinder and the rolling basket cylinder.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112 (f).

1. A hydraulic control system for an agricultural implement, comprising a hydraulic circuit configured to:
receive hydraulic fluid from a first end of a gauge device cylinder, wherein the gauge device cylinder is configured to couple to a tool frame of the agricultural implement and to a gauge device frame of the agricultural implement; and
control a pressure of the hydraulic fluid within a first end of a frame force cylinder based on a pressure of the hydraulic fluid within the first end of the gauge device cylinder, wherein the frame force cylinder is configured to couple to the tool frame, and the frame force cylinder is configured to apply a frame force to the tool frame.

2. The hydraulic control system of claim 1, wherein the hydraulic circuit comprises an unloading valve configured to receive the hydraulic fluid from the first end of the gauge device cylinder, and the unloading valve is configured to control the pressure of the hydraulic fluid within the first end of the frame force cylinder based on the pressure of the hydraulic fluid within the first end of the gauge device cylinder.

3. The hydraulic control system of claim 2, wherein the unloading valve comprises an unloading relief valve configured to receive the hydraulic fluid from the first end of the gauge device cylinder and the hydraulic fluid from the first end of the frame force cylinder, and the unloading relief valve is configured to relieve the pressure of the hydraulic fluid within the first end of the frame force cylinder in response to the sum of the pressure of the hydraulic fluid within the first end of the gauge device cylinder and the pressure of the hydraulic fluid within the first end of the frame force cylinder exceeding a threshold value.

4. The hydraulic control system of claim 2, wherein the hydraulic circuit comprises a pressure relieving valve and a pressure reducing valve, the pressure relieving valve is fluidly coupled to the unloading valve, the pressure reducing valve is fluidly coupled to the unloading valve, the pressure reducing valve is fluidly disposed between a fluid source and the first end of the frame force cylinder, the pressure relieving valve is fluidly disposed between the first end of the frame force cylinder and a tank, and the unloading valve is configured to control the pressure reducing valve and the pressure relieving valve to control the pressure of the hydraulic fluid within the first end of the frame force cylinder.

5. The hydraulic control system of claim 1, wherein the hydraulic circuit comprises a pilot operated check valve fluidly coupled to a second end of the gauge device cylinder and to a tank, and the pilot operated check valve is configured to open based on the pressure of the hydraulic fluid within the first end of the gauge device cylinder.

6. The hydraulic control system of claim 1, wherein the hydraulic circuit is configured to control a pressure of the hydraulic fluid within a second end of the frame force cylinder based on a pressure of the hydraulic fluid within a second end of the gauge device cylinder.

7. The hydraulic control system of claim 6, wherein the hydraulic circuit comprises an unloading valve configured to receive the hydraulic fluid from the second end of the gauge device cylinder, and the unloading valve is configured to control the pressure of the hydraulic fluid within the second end of the frame force cylinder based on the pressure of the hydraulic fluid within the second end of the gauge device cylinder.

8. The hydraulic control system of claim 7, wherein the hydraulic circuit comprises a pressure relieving valve and a pressure reducing valve, the pressure relieving valve is fluidly coupled to the unloading valve, the pressure reducing valve is fluidly coupled to the unloading valve, the pressure reducing valve is fluidly disposed between a fluid source and the second end of the frame force cylinder, the pressure relieving valve is fluidly disposed between the second end of the frame force cylinder and a tank, and the unloading valve is configured to control the pressure reducing valve and the pressure relieving valve to control the pressure of the hydraulic fluid within the second end of the frame force cylinder.

9. A tillage implement, comprising:
a main frame configured to support a plurality of disc blades;
a gauge device frame pivotally coupled to the main frame, wherein the gauge device frame is configured to support a gauge device;
a hitch assembly pivotally coupled to the main frame;
a gauge device cylinder coupled to the main frame and to the gauge device frame;
a tilt cylinder coupled to the hitch assembly and to the main frame, wherein the tilt cylinder is configured to apply a tilt force to the main frame; and
a hydraulic control system comprising a hydraulic circuit configured to:
receive hydraulic fluid from a first end of the gauge device cylinder; and
control a pressure of the hydraulic fluid within a first end of the tilt cylinder based on a pressure of the hydraulic fluid within the first end of the gauge device cylinder.

10. The tillage implement of claim 9, wherein the hydraulic circuit comprises an unloading valve configured to receive the hydraulic fluid from the first end of the gauge device cylinder, and the unloading valve is configured to control the pressure of the hydraulic fluid within the first end of the tilt cylinder based on the pressure of the hydraulic fluid within the first end of the gauge device cylinder.

11. The tillage implement of claim 10, wherein the unloading valve comprises an unloading relief valve configured to receive the hydraulic fluid from the first end of the gauge device cylinder and the hydraulic fluid from the first end of the tilt cylinder, and the unloading relief valve is configured to relieve the pressure of the hydraulic fluid within the first end of the tilt cylinder in response to the sum of the pressure of the hydraulic fluid within the first end of the gauge device cylinder and the pressure of the hydraulic fluid within the first end of the tilt cylinder exceeding a threshold value.

12. The tillage implement of claim 10, wherein the hydraulic circuit comprises a pressure relieving valve and a pressure reducing valve, the pressure relieving valve is fluidly coupled to the unloading valve, the pressure reducing valve is fluidly coupled to the unloading valve, the pressure reducing valve is fluidly disposed between a fluid source and the first end of the tilt cylinder, the pressure relieving valve is fluidly disposed between the first end of the tilt cylinder and a tank, and the unloading valve is configured to control the pressure reducing valve and the pressure relieving valve to control the pressure of the hydraulic fluid within the first end of the tilt cylinder.

13. The tillage implement of claim 9, wherein the hydraulic circuit comprises a pilot operated check valve fluidly coupled to a second end of the gauge device cylinder and to a tank, and the pilot operated check valve is configured to open based on the pressure of the hydraulic fluid within the first end of the gauge device cylinder.

14. The tillage implement of claim 9, wherein the hydraulic circuit is configured to control a pressure of the hydraulic fluid within a second end of the tilt cylinder based on a pressure of the hydraulic fluid within a second end of the gauge device cylinder.

15. The tillage implement of claim 14, wherein the hydraulic circuit comprises an unloading valve configured to receive the hydraulic fluid from the second end of the gauge device cylinder, and the unloading valve is configured to control the pressure of the hydraulic fluid within the second end of the tilt cylinder based on the pressure of the hydraulic fluid within the second end of the gauge device cylinder.

16. The tillage implement of claim 15, wherein the hydraulic circuit comprises a pressure relieving valve and a pressure reducing valve, the pressure relieving valve is fluidly coupled to the unloading valve, the pressure reducing valve is fluidly coupled to the unloading valve, the pressure reducing valve is fluidly disposed between a fluid source and the second end of the tilt cylinder, the pressure relieving valve is fluidly disposed between the second end of the tilt cylinder and a tank, and the unloading valve is configured to control the pressure reducing valve and the pressure relieving valve to control the pressure of the hydraulic fluid within the second end of the tilt cylinder.

17. A hydraulic control system for an agricultural tillage implement, comprising a hydraulic circuit comprising:
a first unloading valve configured to receive hydraulic fluid from a first end of a gauge device cylinder, wherein the gauge device cylinder is configured to couple to a main frame of the agricultural tillage implement and to a gauge device frame of the agricultural tillage implement, the unloading valve is configured to control a pressure of the hydraulic fluid within a first end of a tilt cylinder based on the pressure of the hydraulic fluid within the first end of the gauge device cylinder, the tilt cylinder is configured to couple to a hitch assembly of the agricultural tillage implement and to the main frame, and the tilt cylinder is configured to apply a tilt force to the main frame;
a second unloading valve configured to receive the hydraulic fluid from a second end of the gauge device cylinder, wherein the second unloading valve is configured to control a pressure of the hydraulic fluid within a second end of the tilt cylinder based on a pressure of the hydraulic fluid within the second end of the gauge device cylinder; and
a third unloading valve configured to receive the hydraulic fluid from the second end of the tilt cylinder, wherein the third unloading valve is configured to control the pressure of the hydraulic fluid within the first end of the tilt cylinder based on the pressure of the hydraulic fluid within the second end of the tilt cylinder.

18. The hydraulic control system of claim 17, wherein the hydraulic circuit comprises:
a first pressure relieving valve fluidly coupled to the first and third unloading valves, wherein the first pressure relieving valve is fluidly disposed between the first end of the tilt cylinder and a tank;
a first pressure reducing valve fluidly coupled to the first and third unloading valves, wherein the first pressure reducing valve is fluidly disposed between a fluid source and the first end of the tilt cylinder;
a second pressure relieving valve fluidly coupled to the second unloading valve, wherein the second pressure relieving valve is fluidly disposed between the second end of the tilt cylinder and the tank; and
a second pressure reducing valve fluidly coupled to the second unloading valve, wherein the second pressure reducing valve is fluidly disposed between the fluid source and the second end of the tilt cylinder;
wherein the first and third unloading valves are configured to control the first pressure reducing valve and the first pressure relieving valve to control the pressure of the hydraulic fluid within the first end of the tilt cylinder, and the second unloading valve is configured to control the second pressure reducing valve and the second pressure relieving valve to control the pressure of the hydraulic fluid within the second end of the tilt cylinder.

19. The hydraulic control system of claim 18, wherein the hydraulic circuit comprises an activation valve fluidly disposed between the fluid source and the second pressure reducing valve, wherein the activation valve is configured to selectively block hydraulic fluid flow between the fluid source and the second pressure reducing valve.

20. The hydraulic control system of claim 17, wherein the hydraulic circuit comprises a pilot operated check valve fluidly coupled to the second end of the gauge device cylinder and to a tank, and the pilot operated check valve is configured to open based on the pressure of the hydraulic fluid within the first end of the gauge device cylinder.
